(19) United States
(12) Patent Application Publication
(10) Pub. No.: US 2007/0044472 A1
(43) Pub. Date: Mar. 1, 2007

(54) Oxygen sensor for an internal combustion engine

(76) Inventor: Guoqing Zhang, Lisle, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(21) Appl. No.: 11/217,569

(22) Filed: Sep. 1, 2005

(51) Int. Cl. F02B 33/44; F02B 29/04

(52) U.S. Cl. 60/605.2; 60/612; 60/599

(57) ABSTRACT

An internal combustion engine (107) having a first turbine (109), a first compressor (103), an intake manifold (106) in fluid communication with the first compressor (103), an exhaust manifold (108) in fluid communication with the first turbine (109), and an oxygen sensor (121) in fluid communication with the intake manifold (106), disposed on an outlet side of the first compressor (103).

### FIELD OF THE INVENTION

This invention relates to internal combustion engines, including but not limited to combustion control.

### BACKGROUND OF THE INVENTION

Use of oxygen sensors is known in the art of internal combustion engines. Oxygen sensors are commonly used to sense oxygen concentration in the exhaust gas of an engine. Information from the oxygen sensor is typically used for controlling or monitoring the quality of combustion in the engine. Commercially available oxygen sensors are designed to operate in the exhaust stream of an engine at high temperatures and in the presence of combustion byproducts.

Use of Exhaust Gas Recirculation (EGR) is common in internal combustion engines. EGR is a method of recirculating exhaust gas into the intake of the engine to dilute incoming air with inert combustion gases to lower the combustion temperature in the cylinders, as is known in the art. The introduction of EGR into the engine limits the fresh air intake of the engine, and therefore limits the amount of oxygen available for combustion. The amount of EGR passing through the engine is typically inferred using temperature, flow, and pressure sensors in the intake system. One disadvantage of typical EGR control systems in internal combustion engines is the low accuracy and low reliability of commercially available sensors used to infer EGR amounts.

Accordingly, there is a need for a more reliable and accurate method of using an oxygen sensor to control the combustion process in an internal combustion engine while taking more accurate measurements and increasing the service life of the oxygen sensor.

### SUMMARY OF THE INVENTION

An internal combustion engine has a first turbine, a first compressor, an intake manifold in fluid communication with the first compressor, an exhaust manifold in fluid communication with the first turbine, and an oxygen sensor. The oxygen sensor is in fluid communication with the intake manifold, and measures the oxygen concentration of fluids exiting the first compressor.

A method for an internal combustion engine is disclosed. Exhaust gas from an exhaust manifold is recirculated to an intake manifold. A quantity of the recirculated exhaust gas is controlled with a valve. The recirculated exhaust gas is mixed with air to yield an intake mixture. The intake mixture is compressed in a compressor. An oxygen concentration of the intake mixture is determined. The intake mixture is routed into the engine.

### BRIEF DESCRIPTION OF THE DRAWINGS

FIG. 1 is a block diagram of an engine with an oxygen sensor in the intake system and an ECM in accordance with the invention.

FIG. 2 is a block diagram of an engine with an oxygen sensor in the intake system between two compressors in accordance with the invention.

FIG. 3 is a block diagram of an engine with an oxygen sensor and a high pressure EGR system, in accordance with the invention.

FIG. 4 is a flowchart for a method of determining an oxygen concentration of an intake mixture in accordance with the invention.

### DESCRIPTION OF A PREFERRED EMBODIMENT

The following describes an apparatus for and method of placing an oxygen sensor in an intake system of an internal combustion engine. The oxygen sensor helps control the amount of oxygen entering the intake system of the engine with improved measurement accuracy and increased service life. The oxygen sensor is placed downstream of a mixing point for EGR, and after a compressor. The accuracy of the measurement taken by the sensor is improved by measuring the oxygen concentration of a homogeneous mixture, as compared to a non-homogeneous mixture, of intake air and recirculated exhaust gas. The service life of the sensor is improved by measuring a compressed mixture at a higher temperature, as compared with measuring a mixture at a lower temperature.

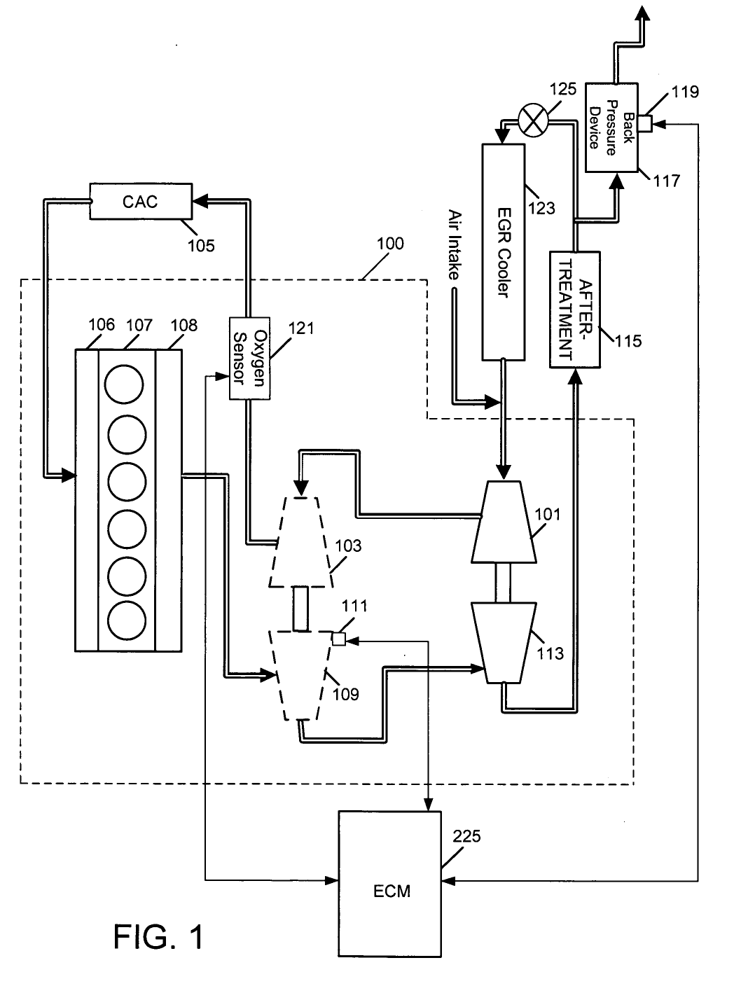

A block diagram for an air system of an internal combustion engine 100 is shown in FIG. 1. During engine operation, fresh air from the environment enters the engine 100 through an inlet of a Low Pressure (LP) compressor 101. An LP turbocharger, in fluid communication with an exhaust manifold 108 and an intake manifold 106, includes an LP turbine 113 and the LP compressor 101. Air is compressed in the LP compressor 101 and routed for further compression to a High Pressure (HP) compressor 103. The HP compressor 103 has an inlet and an outlet. The inlet of the HP compressor 103 is in fluid communication with an outlet of the LP compressor 101, and the outlet of the HP compressor 103 is in fluid communication with the intake manifold 106. Compressed air from the outlet of the HP compressor 103 may be cooled in a Charge Air Cooler (CAC) 105 before entering the engine 100 through the intake manifold 106. Air or an intake mixture of air and exhaust gas enters the engine 100 where it is typically mixed with fuel within a plurality of cylinders disposed in a crankcase 107 yielding a fuel-air mixture. The fuel-air mixture combusts releasing energy.

An emission control and treatment system for the engine 100 includes an after-treatment module 115 fluidly connected to an outlet of the LP turbine 113, an EGR cooler 123 fluidly connected to an EGR valve 125, and a backpressure device 117 with a backpressure device actuator 119.

Incoming air from the environment, or fresh air, is mixed with exhaust gas from the exhaust system at a location downstream of the after-treatment module 115 and upstream of the backpressure device 117 during engine operation. The exhaust gas is cooled in the EGR cooler 123 before mixing with the intake air. An EGR valve 125 controls the quantity of exhaust gas being cooled. The cooled exhaust gas is mixed with the incoming air at a location upstream of the LP compressor 101.

The intake mixture of air and exhaust gas, passes through at least one compressor, passes over an oxygen sensor 121, and then enters the CAC 105. In the embodiment shown in FIG. 1, the engine 100 has two compressors 101 and 103 that compress the mixture before it passes over the oxygen sensor 121. The oxygen sensor 121 may be an oxygen sensor model number OXY6200 Engine Oxygen Monitor, manufactured by ECM, having a range of 0.0 to 25.0 percent oxygen and an accuracy of better than +/−0.1 percent oxygen. For engines with only one compressor, the mixture passes through the compressor and then passes over the oxygen sensor 121. In the embodiment shown in FIG. 1, the oxygen sensor 121 is located in fluid communication with the outlet of the HP compressor 103.

An Electronic Control Module (ECM) 225 is also shown in FIG. 1. The ECM 225 is configured to accept signals from various sensors located on the engine 100 or elsewhere on a vehicle. Functions performed by the ECM 225 include determining a desired operating condition of the engine 100 and commanding positions to various actuators on the engine, as well as controlling the operation of the fueling system of the engine.

A signal from the oxygen sensor 121 may be relayed to the ECM 225 for processing. The ECM 225 may use this signal to determine the concentration of oxygen in the mixture of intake air and exhaust gas, compare the determined value of the oxygen concentration with a desired value, and command positions or settings to various engine components including a turbine actuator 111, the backpressure device actuator 119, and the EGR valve 125. The motion or settings of the various actuators under the control of the ECM 225 intend to bring the oxygen concentration in the intake of the engine 100 closer to a desired value.

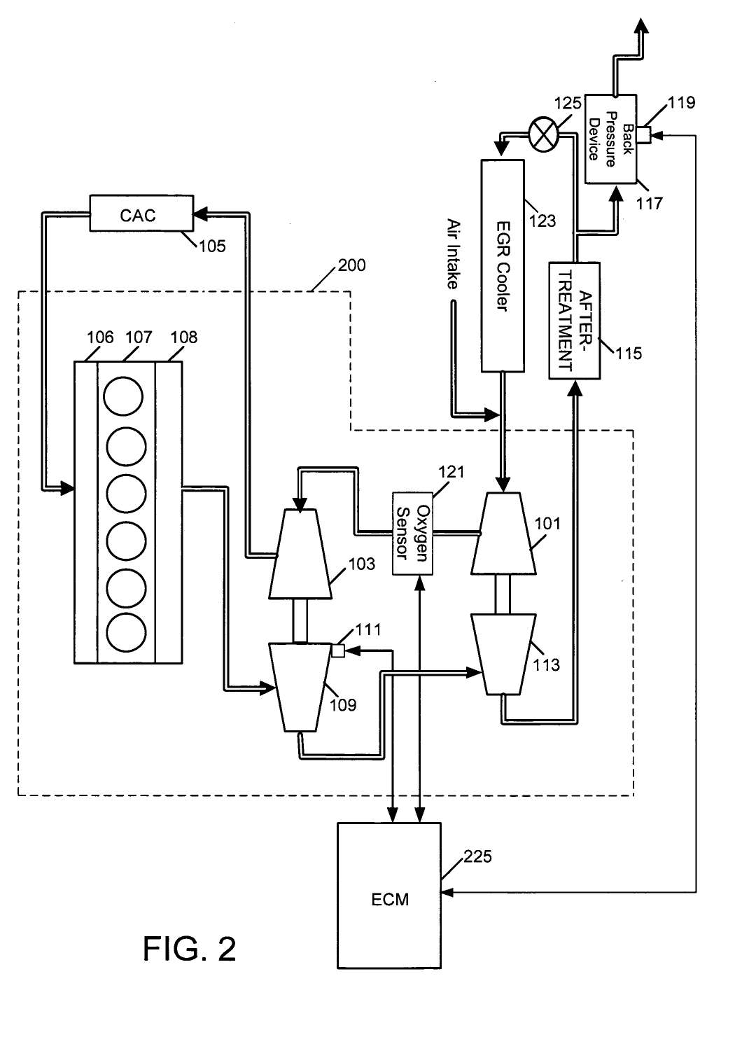

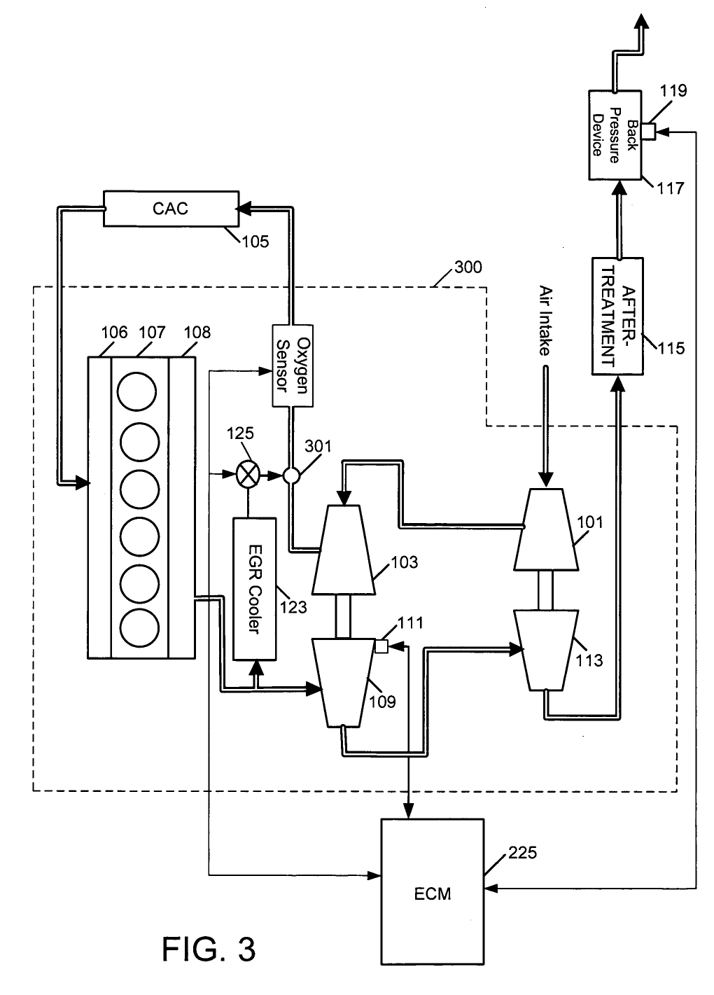

Alternatively, the oxygen sensor 121 may be located upstream of the HP compressor 103 and downstream of the LP compressor 101, as shown in FIG. 2. Components of the EGR system are arranged in a high pressure loop, i.e., the exhaust gas comes from upstream of the HP turbine 109 or the LP turbine 113 and is mixed with intake air downstream of the LP compressor 101 or the HP compressor 103, as shown in FIG. 3. The location of the oxygen sensor 121 for the arrangement of FIG. 3 is after an EGR mixing junction 301.

The HP turbine 109 may advantageously be a variable geometry turbine, and may also be the only turbine on the engine. The LP turbine 113 is optional, and its use depends on the requirements of different engine applications. The HP compressor 103 may also have a variable geometry capability, while the LP compressor 101 is also optional. The backpressure device 117 may be used to drive additional EGR gas into the engine 100, or may also be used for engine warm-up, and is also optional. The EGR valve 125 may be placed anywhere between the exhaust system and the intake system of the engine in any of the embodiments shown in FIG. 1 through FIG. 3.

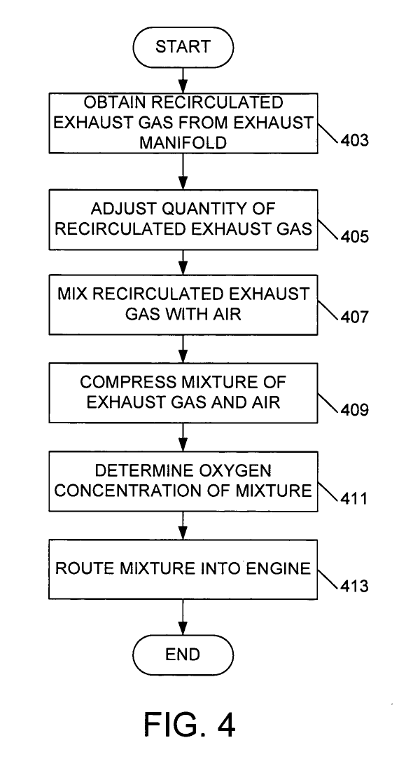

A flowchart for a method of determining an oxygen concentration of a mixture is presented in FIG. 4. Exhaust gas is obtained from the exhaust manifold 108 at step 403. The quantity of the exhaust gas is adjusted at step 405 by the EGR valve 125 according to the requirements of the engine 100. The desired exhaust gas quantity is mixed with the incoming engine air at step 407. An intake mixture of exhaust gas and air is compressed at step 409. The compressed intake mixture is passed over an oxygen sensor 121 at step 411 before entering the engine. A signal from the oxygen sensor 121 is sent to the ECM 225 where the oxygen concentration of the intake mixture is determined. After passing over the oxygen sensor 121, the intake mixture is routed to the engine 100 for combustion. The method can be repeated as required.

The determined oxygen concentration of the intake mixture may be used to control the internal combustion engine. For example, a known oxygen concentration of an intake mixture allows for direct control of the air-to-fuel ratio (AFR) of the engine. Control of the AFR enables for clean and efficient operation of the engine. If a higher AFR is required, i.e. more air and less fuel to make the engine run leaner, less fuel may be commanded for a determined amount of air as inferred by the oxygen concentration of the intake mixture. Conversely, if a lower AFR is required, i.e. less air and more fuel to make the engine run richer, more fuel may be commanded for a determine amount of air as inferred by the oxygen concentration of the intake mixture. Additionally, the oxygen concentration of the intake mixture allows for control of the amount of EGR entering the engine. To lower the oxygen concentration, for example, an engine may add more EGR gas by commanding an EGR valve to open. Conversely, to increase to the oxygen concentration, an engine may command less EGR gas, thus allowing the engine to ingest more fresh air, by decreasing the opening of an EGR valve.

Placement of the oxygen sensor 121 downstream of at least one compressor is advantageous because the intake mixture of air and exhaust gas exiting the compressor has at least two desirable characteristics in that the intake mixture is homogeneous because it has mixed well by passing through the compressor, and the temperature of the intake mixture is elevated by the compression. The measurement accuracy and service life of an oxygen sensor increase with the advantageously improved homogeneity and the increased temperature of the mixture being measured. In the embodiments presented, the homogeneity of the intake air with exhaust gas mixture provides higher measurement accuracy in the reading of the oxygen sensor 121, because the value obtained for the oxygen concentration of the mixture is more representative of the composition of the mixture entering the engine. Measurements of a non homogeneous mixture will yield inaccurate values for the oxygen concentration of the mixture entering the engine. Furthermore, the elevated temperature of the mixture after compression may be adequately high to fall within the design specification limits of the oxygen sensor 121. Operation of the oxygen sensor 121 at higher temperatures aids in increasing service life. These attributes are desirable and advantageous because they increase the measurement accuracy and reliability of the oxygen sensor 121.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An internal combustion engine comprising:
a first compressor having a first compressor inlet and a first compressor outlet;
an intake manifold in fluid communication with the first compressor outlet;
an oxygen sensor disposed in fluid communication with the intake manifold, wherein the oxygen sensor is disposed in an intake air passage disposed between the first compressor outlet and the intake manifold.

2. The internal combustion engine of claim 1, further comprising an exhaust gas recirculation system having at least one cooler disposed in fluid communication with the first compressor inlet and at least one valve disposed in fluid communication with the cooler.

3. The internal combustion engine of claim 2, further comprising an electronic control module arranged and constructed to communicate with the oxygen sensor and the valve.

4. The internal combustion engine of claim 1, wherein the oxygen sensor is disposed downstream of the first compressor.

5. The internal combustion engine of claim 4, further comprising a second turbocharger that includes a second turbine having a second turbine inlet disposed in fluid communication with a first turbine inlet, and a second compressor having a second compressor inlet disposed in fluid communication with the first compressor outlet.

6. The internal combustion engine of claim 5, wherein the oxygen sensor is disposed downstream of the first compressor and upstream of the second compressor.

7. The internal combustion engine of claim 4, wherein the first turbine is capable or variable flow area.

8. The internal combustion engine of claim 7, further comprising a turbine actuator arranged and constructed to vary the variable flow area of the first turbine.

9. The internal combustion engine of claim 1, wherein the first compressor is driven by at least one of: a gas turbine, mechanical power, and electrical power.

10. A method comprising the steps of:
introducing a known quantity of exhaust gas from an exhaust manifold upstream of a compressor;
adjusting the known quantity of exhaust gas obtained using a valve;
mixing the known quantity of exhaust gas with air in an intake system of an engine, yielding an intake mixture;
compressing the intake mixture;
determining an oxygen concentration of the intake mixture;
routing the intake mixture to an intake manifold of an internal combustion engine;
using the oxygen concentration of the intake mixture to control the internal combustion engine.

11. The method of claim 10, wherein the step of determining the oxygen concentration of the intake mixture is accomplished with an oxygen sensor disposed in fluid communication with the intake manifold at a location downstream of a compressor.

12. The method of claim 10, further comprising the step of compressing the intake mixture for a second time using a second compressor, wherein an oxygen sensor is disposed in fluid communication with the intake manifold at a location upstream of the second compressor, and downstream of a first compressor.

13. The method of claim 10, further comprising the steps of:
sensing the oxygen concentration of the intake mixture using an oxygen sensor;
sending a signal from the oxygen sensor to an electronic control module;
calculating the oxygen concentration of the intake mixture within the electronic control module.

14. The method for an internal combustion engine of claim 13, further comprising the step of calculating a position for the valve in the electronic control module based on the calculated concentration of oxygen in the intake mixture.

15. The method for an internal combustion engine of claim 13, further comprising the step of commanding a position to an actuator that varies the flow area of a turbine based on the calculated concentration of oxygen in the intake mixture.

16. An internal combustion engine comprising:
a first turbocharger having a first turbine and a first compressor;
an intake manifold in fluid communication with the first compressor;
a charge air cooler, in fluid communication with the intake manifold, and disposed between the intake manifold and the first compressor;
an exhaust manifold in fluid communication with the first turbine;
an exhaust gas recirculation system, the exhaust gas recirculation system in fluid communication with the exhaust manifold, and in fluid communication with the intake manifold at a junction; and
an oxygen sensor disposed in fluid communication with the intake manifold; wherein the oxygen sensor is disposed between the charge air cooler and the junction.

17. The internal combustion engine of claim 16, further comprising an electronic control module operably connected to the oxygen sensor.

18. The internal combustion engine of claim 16, wherein the first turbine is arranged and constructed for variable flow area.

19. The internal combustion engine of claim 18, further comprising a turbine actuator, wherein an electronic control module sends position commands to the turbine actuator.

20. The internal combustion engine of claim 16, further comprising a second turbocharger in fluid communication with the first turbocharger.
